(19) United States
(12) Patent Application Publication
(10) Pub. No.: US 2004/0233044 A1
(43) Pub. Date: Nov. 25, 2004

(54) Racing muzzle and bridle

(76) Inventors: Yolanda K. Carter, Montgomery, AL (US); Tiffany Bedgood, Montgomery, AL (US)

Correspondence Address: Richard C. Litman, LITMAN LAW OFFICES, LTD., P.O. Box 15035, Arlington, VA, 22215, US

(21) Appl. No.: 10/442,942

(22) Filed: May 22, 2003

(51) Int. Cl. G08B 23/00

(52) U.S. Cl. 340/323 R; 368/9; 340/573.3

(57) ABSTRACT

A racing device for a racing dog that utilizes a muzzle with a front end, that is worn on the face of the racing dog while racing, and a transceiver, that is placed on the front end of the muzzle and emits a signal. There is a receiving station, located at the finish line of a race, that receives the emitted signal from the transceiver, indicating when the transceiver crosses the finish line. There is also a timer, used in combination with the receiving station, that indicates what time the transceiver crosses the finish line. The invention includes GPS, RF and laser technologies and also includes an embodiment for a racing horse.

### BACKGROUND OF THE INVENTION

1. Field of the Invention

The present invention relates to a racing muzzle and bridle. More specifically, the present invention utilizes various signal technologies on the tip of the racing muzzle and bridle, to determine the winner in a closely contested dog or horse race.

2. Description of the Related Art

Animal racing, such as horse racing and dog racing, has always been popular. Many races are close enough for organizers to use photo-finish technology to determine the exact order in which participants finish a particular race. This technology is known and is reflected in the related art.

United States Patent Application Publication Number 2001/0040508 published on Nov. 15, 2001, outlines the use of a system apparatus for controlling the whereabouts of an animal. The system includes a receiver/stimulator unit, affixed to the animal, to selectively administer appropriate aversive stimuli. The stimuli deters the animal from encroachment of boundaries, in accordance with predetermined conditions, based on radio signals received from at least one battery powered transmitter. The system may receive radio signals intermittently transmitted from the transmitter, the radio signals defining at least one boundary for the animal.

United States Patent Application Publication Number 2003/0058113 published Mar. 27, 2003, outlines the use of a method for identifying and tracking a plurality of individual animals, and includes the initial step of a manufacturer creating a plurality of electronic identifications (EID)s, with each having a unique number. A livestock producer requests a plurality of EIDs from the manufacturer, and the manufacturer forwards the numbers of the EIDs, shipped to the producer, along with identification data for that producer, to an essential data warehouse. The warehouse creates a prerecord in a central database from the EID number and identification, for the producer, and communicates with the producer, to permit access to the prerecords for that producer.

U.S. Pat. No. 3,829,869 issued to Balko et al., outlines the use of a photo finish camera and system, for producing a time sequence photographic record of racing contestants at a finish line, with visual indications of elapsed time calibrated in the photograph with the images.

U.S. Pat. No. 5,103,433 issued to Imhof, outlines the use of a method and apparatus for ascertaining the times which elapse during contests between animate and/or inanimate participants of races and other contests. Such contests include contests between motor vehicles, human beings, animals and/or human beings on animals or in motor vehicles or other types of vehicles.

U.S. Pat. No. 5,630,186 issued to Yamaguchi, outlines the use of moving body cameras for taking photographs of objects and information characters moving with high speed. More particularly, the cameras are utilized for judging the arrival order in horse races, bicycle races, boat races, automobile races and the like.

U.S. Pat. No. 5,671,010 issued to Shimbo et al., outlines the use of an apparatus for judging the order of arrival of racers at a judgment criterion line, such as a goal line in a race and time taken for the race, having television cameras using line sensors.

U.S. Pat. No. 5,689,099 issued to Domburg, outlines the use of a method and assembly for measuring the speed of or distance covered by a runner. According to the invention, the angular displacement of the foot is measured, and the distance of the trunk from a reference, such as a foot or the ground, is determined. On the basis of this data, it is possible to calculate speed or distance traveled.

U.S. Pat. No. 5,724,265 issued to Hutchings, outlines the use of a device that measures the distance traveled, speed and height jumped of a person running or walking. Accelerometers and rotational sensors are placed in the sole of one shoe along with an electronic circuit, that performs mathematical calculations, to determine the distance and height of each step. A radio frequency transmitter sends the distance and height information to a wristwatch or other central receiving unit. A radio frequency receiver in the wristwatch is coupled to a microprocessor that calculates an output speed, based upon step-distance and elapsed time, and the distance traveled of the runner from the sum of all previous step distances.

U.S. Pat. No. 5,737,280 issued to Kokubo, outlines the use of a clocking system for measuring the running speeds of track runners, and more particularly, to a clocking system which incorporates electrical or ultrasonic sensor means for monitoring the physical conditions of individual runners working on an exercising track or the like. The individual runners are in relation with a clocking operation measuring lap times or split times, at predetermined clocking points for individual runners on the track.

U.S. Pat. No. 5,812,049 issued to Uzi, outlines the use of a system for monitoring the time and location of a participant in a competitive activity. This includes a memory apparatus for storing event performance parameters and the identity of the participant. There is also a clock apparatus for determining the event times of the participant and a control apparatus associated with the clock apparatus and the memory apparatus, for receiving as input data, the event times of the participant and for determining event performance parameters in accordance with and for storing the parameters in the memory apparatus.

Although each of these outlined inventions are useful and novel, what is really needed is a racing muzzle or bridle that can be part of a system at the finish line of a particular race to indicate close finishes, as opposed to using a photograph finish system. Such a racing muzzle or bridle would be would be in high demand for races involving dogs or horses and would be very successful in the marketplace.

None of the above inventions and patents, taken either singly or in combination, is seen to describe the instant invention as claimed. Thus a racing muzzle and bridle solving the aforementioned problems is desired.

### SUMMARY OF THE INVENTION

The invention is a racing device for a racing dog that utilizes a muzzle with a front end, that is worn on the face of the racing dog while racing, and a transceiver, that is placed on the front end of the muzzle and emits a signal. There is a receiving station, located at a finish line of a race, that receives the emitted signal from the transceiver, indicating when the transceiver crosses the finish line. There is also a timer, used in combination with the receiving station, that indicates what time the transceiver crosses the finish line. The invention includes GPS, RF and laser technologies and also includes an embodiment for a racing horse.

Accordingly, it is a principal object of the invention to provide a racing muzzle or bridle for use in dog or horse racing.

It is another object of the invention to provide a better way of determining closely contested dog and horse races, other than photo-finishing technologies.

It is a further object of the invention to provide an inexpensive but accurate way of determining closely contested dog or horse races, other than photo-finishing technologies.

It is an object of the invention to provide improved elements and arrangements thereof for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

FIG. 1 is an environmental, perspective view of a racing muzzle for a racing dog, according to the present invention.

FIG. 2A is a side perspective view of the racing muzzle for a racing dog.

FIG. 2B is a side perspective view of a racing bridle for a racing horse.

FIG. 3 is a signaling diagram of how the racing muzzle and bridle work.

Similar reference characters denote corresponding features consistently throughout the attached drawings.

### DETAILED DESCRIPTION OF THE PREFERRED EMBODIMENT

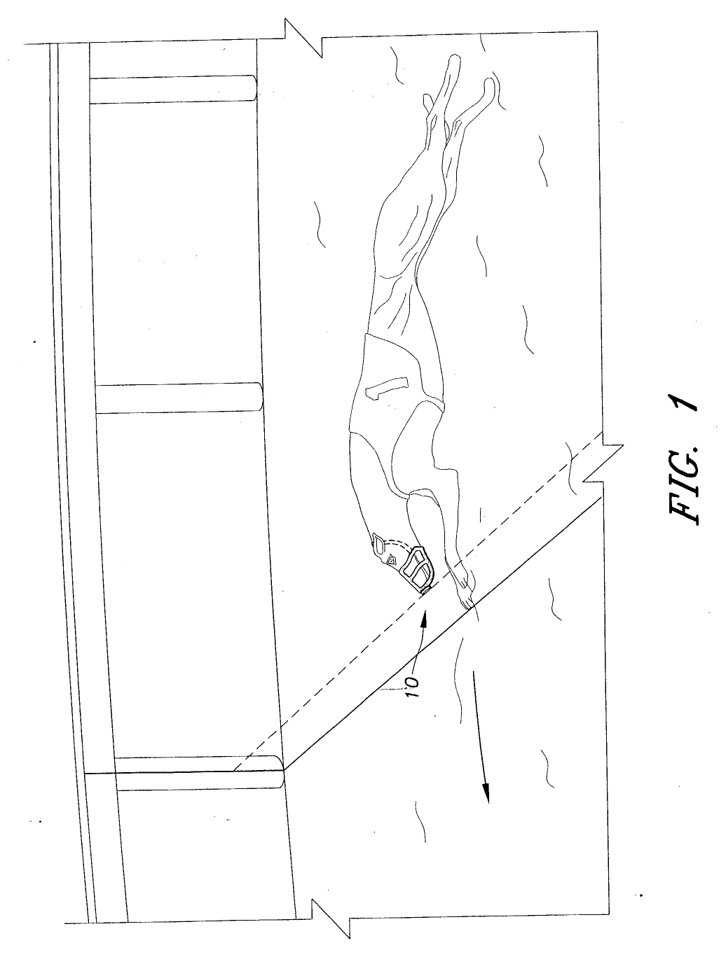

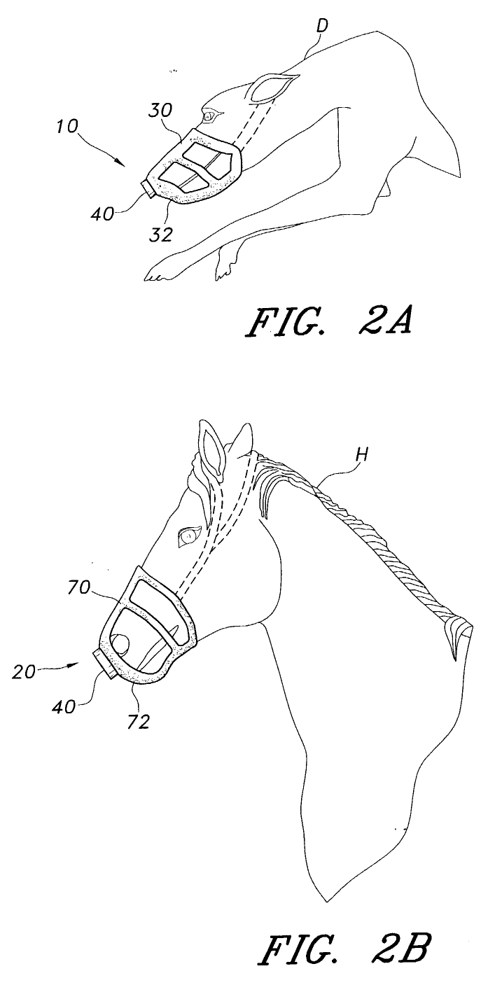

The present invention is a racing device for a racing dog 10 with a face, as is depicted in FIG. 1. FIG. 2A depicts the racing device for a racing dog 10, while FIG. 2B depicts a second racing device for a racing horse 20.

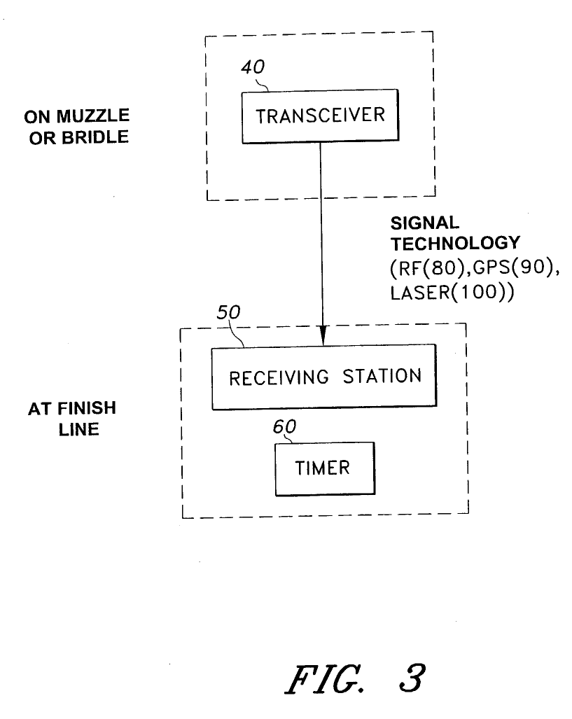

As is shown in FIG. 2A and FIG. 3, the racing device for a racing dog 10 comprises a muzzle 30 with a front end 32, that is worn on the face of the racing dog D while racing, and a transceiver 40 that is placed on the front end 32 of the muzzle 30 and emits a signal. There is a receiving station 50, located at the finish line of a race, that receives the emitted signal from the transceiver 40, indicating when the transceiver 40 crosses the finish line and a timer 60, used in combination with the receiving station 50, that indicates what time the transceiver 40 crosses the finish line.

Similarly, as shown in FIG. 2B and FIG. 3, the device for a racing horse 20 with a face, comprises a bridle 70 with a front end 72, that is worn on the face of the racing horse H while racing, and a transceiver 40 that is placed on the front end 72 of the bridle 70 and emits a signal. Like the racing device for a racing dog 10, there is also a receiving station 50, located at the finish line of a race, that receives the emitted signal from the transceiver 40, indicating when the transceiver 40 crosses the finish line. There is also a timer 60, used in combination with the receiving station 50, that indicates what time the transceiver 40 crosses the finish line.

Both the racing device for a racing dog 10 and the racing device for a racing horse 20 can be used to show the precise order in which a group of racing dogs D or racing horses H wearing the muzzle 30 or bridle 70, cross the finish line of a particular race. The transceivers 40 on each respective racing dog D or racing horse H can have different frequencies, thereby differentiating themselves from one another when grouped together in a race and crossing the finish line of a race.

As is depicted in FIG. 3, there are several signal technologies that are known that can be used with the racing device for a racing dog 10 and the racing device for a racing horse 20. As indicated previously, radio frequency technology 80 radio frequencies, can be used with the transceiver 40 and the receiving station 50, for signal technology as well as GPS technology 90 and laser technology 100. Use of GPS technology 90 and laser technology 100, each requires use of the appropriate transceivers 40 and receiving stations 50, which are well-known to those schooled in the related art and are technically different than the transceivers 40 and receiving stations 50 used in RF technology 80.

Use of the racing device for a racing dog 10 or racing device for a racing horse 20 is uncomplicated. Both the muzzle 30 and bridle 70 can be manually put on and taken off of the animal. The radio frequency technology 80, the GPS technology 90 and laser technology 100 and their respective components (i.e., transceiver 40 and receiving station 50.) are well-known to those schooled in the related art. The application of each of these technologies and their use for dog racing and horse racing, however, are novel.

It is to be understood that the present invention is not limited to the embodiment described above, but encompasses any and all embodiments within the scope of the following claims.

We claim:

1. A racing device for a racing dog with a face, during a race with a finish line, comprising:
a muzzle with a front end, that is worn on the face of the racing dog while racing;
a transceiver that is placed on the front end of the muzzle and emits a signal;
a receiving station, located at the finish line of the race, that receives the emitted signal from the transceiver, indicating when the transceiver crosses the finish line; and
a timer, used in combination with the receiving station, that indicates what time the transceiver crosses the finish line.

2. The device according to claim 1, wherein the signal emitted utilizes GPS technology.

3. The device according to claim 1, wherein the signal emitted utilizes differing radio frequency technology.

4. The device according to claim 3, wherein a plurality of transceivers are used by a plurality of racing dogs, with each racing dog having its own transceiver set at a different frequency than that of other racing dogs.

5. The device according to claim 1, wherein the signal emitted utilizes laser technology.

6. The device according to claim 1, wherein the timer is digital.

7. The device according to claim 1, wherein the timer is analog.

8. A device for a racing horse with a face, during a race with a finish line, comprising:
a bridle with a front end, that is worn on the face of the racing horse while racing;
a transceiver that is placed on the front end of the bridle and emits a signal;
a receiving station, located at the finish line of the race, that receives the emitted signal from the transceiver, indicating when the transceiver crosses the finish line; and
a timer, used in combination with the receiving station, that indicates what time the transceiver crosses the finish line.

9. The device according to claim 8, wherein the signal emitted utilizes GPS technology.

10. The device according to claim 8, wherein the signal emitted utilizes radio frequency technology.

11. The device according to claim 10, wherein a plurality of transceivers are used by a plurality of racing horses, with each racing horse having its own transceiver set at a different frequency than that of other racing horses.

12. The device according to claim 8, wherein the signal emitted utilizes laser technology.

13. The device according to claim 8, wherein the timer is digital.

14. The device according to claim 8, wherein the timer is analog.
